(19) United States
(12) Patent Application Publication
(10) Pub. No.: US 2023/0227667 A1
(43) Pub. Date: Jul. 20, 2023

(54) BIOCIDAL, ANTISEPTIC, NON-SOLVENT-BASED ENVIRONMENTALLY-FRIENDLY COATING CONTAINING METAL PARTICLES HAVING A FLAT LAMELLAR STRUCTURE

(71) Applicant: Stéphane MAGGUILLI, Chally-Montreux (CH)

(72) Inventor: Michel DESBOIS, Nieul Sur Mer (FR)

(21) Appl. No.: 17/998,290

(22) PCT Filed: May 11, 2021
(86) PCT No.: PCT/EP2021/062556

§ 371 Date: Nov. 9, 2022

(30) Foreign Application Priority Data
May 11, 2020 (FR) FR2004636

(51) Int. Cl. C09D 5/14; C09D 7/20; C09D 7/61; C09D 163/00; C09D 7/40

(52) U.S. Cl. CPC C09D 5/14; C09D 7/20; C09D 7/61; C09D 163/00; C09D 7/66; C09D 7/70

(57) ABSTRACT

The present invention relates to a biocidal coating composition for a surface, comprising overlapping flat lamellar metallic nanoparticles and/or microparticles having a diameter of less than 45 microns, in suspension in a binder comprising an epoxy resin, a thixotropic agent and a natural diluent selected from among water, preferably demineralized water, and/or ethylene glycol and/or denatured alcohol. Moreover, the invention also relates to a coating process comprising a step of applying said composition, and to the use of the coating composition according to the invention for coating a surface.

The present invention relates to a biocidal coating composition for a surface, comprising overlapping flat lamellar metallic nanoparticles and/or microparticles having a diameter of less than 45 microns, in suspension in a binder comprising an epoxy resin, a thixotropic agent and a natural diluent selected from among water, preferably demineralized water, and/or ethylene glycol and/or denatured alcohol. Moreover, the invention also relates to a coating process comprising a step of applying said composition, and to the use of the coating composition according to the invention for coating a surface.

### PRIOR ART

Copper has antibacterial properties that have been known for centuries. Man has used the naturally antibacterial properties of copper since the earliest of times. It has been clearly demonstrated by numerous scientific studies conducted over the decades that copper is capable of eradicating the most resistant bacteria, molds and viruses. It is also known that its properties are used for the prevention of nosocomial infections.

Scientific literature cites the efficacy of copper in killing and deactivating several types of pathogenic bacteria, molds and viruses, including: Acinetobacter baumannii; Adenovirus; Aspergillus niger; Candida albicans; Campylobacter jejuni; Clostridioides difficile; Enterobacter aerogenes; Escherichia coli O157:H7; Helicobacter pylori; Influenza A (H1N1); Legionella pneumophila; Listeria monocytogenes; Poliovirus; Pseudomonas aeruginosa; Salmonella enteritidis; Tubercle bacillus; Staphylococcus aureus; vancomycin-resistant Enterococcus and methicillin-resistant Staphylococcus aureus.

Submerged surfaces such as the hulls of ships must be protected against the development thereon of algae or marine animals, without which protection the durability and functionality of the structures forming these surfaces would be considerably affected. In particular, the resistance of the hulls of ships to gliding through the water would be considerably increased and the surfaces of these hulls could be damaged.

It is well known that this protection can be ensured using so-called anti-fouling paints. Effective paints have the major disadvantage of containing toxic particles that spread to the environment, and new international standards related to environmental protection are increasingly restrictive in this regard. Paints that respect these international standards, especially paints intended for pleasure boats, have the disadvantage of being clearly less effective than previous paints, leading to more frequent careening of the boats and thus prolonged periods of immobilization thereof, as well as increased operating costs.

For such anti-fouling paints or coatings, it is known that copper or copper and nickel alloy particles in suspension in a binder can be used. These paints or coatings, however, do not provide complete satisfaction in terms of the effectiveness of the protection of submerged surfaces and respect for the environment.

Document U.S. Pat. No. 5,284,682 discloses a coating made up of lamellar particles, necessarily isolated from each other to inhibit corrosion of metallic surfaces to which said coating has been applied. Moreover, the composition disclosed by this document does not use natural solvents.

Document FR2894974 discloses a product for the protection of a surface intended to be submerged such as the hull of a ship, comprising spaced out particles, a binder and a diluent.

The configuration of these coatings promotes the microscopic confinement of air molecules (oxygen), conducive to the proliferation of bacteria and/or molds and/or fungi, furthermore causing the destruction of the substrate, made of polyester, due to the presence of water and acetic acid, produced by hydrolysis of the resin, leading to the entrance of water, with a significant risk of irreversible damage to the submerged portion of the hull of the ship. Moreover, the dispersion of said nanoparticles and/or microparticles into the environment cannot be avoided due to the chosen conformation, allowing viruses and microbes to form and air to be confined, which affects the antiseptic properties of the copper, which cannot be conserved.

Document WO2016/081476 discloses a composition comprising nonmetallic particles, an epoxy resin and a natural solvent. The absence of a dispersion agent is problematic, because said particles are not held in suspension.

Moreover, most current compositions systematically use powders with a cylindrical structure, preferably spherical, with a granulometry greater than or equal to 45 microns. Said particles have irregular shapes in relation to each other, having a lower cost of production that does not allow for continuity in the ionic properties of the copper and/or cupronickel. Their irregular shapes and their overlapping promote the microscopic confinement of air molecules (oxygen), conducive to the proliferation of bacteria and/or molds and/or fungi. In nautical sports, for example, this promotes the destruction of the substrate, made of polyester, due to the presence of water and acetic acid, produced by hydrolysis of the resin, leading to the entrance of water, with a significant risk of irreversible damage to the submerged portion of the hull of the ship.

These cylindrical powders, preferably spherical, have a so-called “round” structure, deforming the initially processed structure, necessitating surfacing with said protection, following their application, which brings about a significant decrease in the thickness of the coating.

Moreover, in the case of copper powder composites, the biocidal properties generated by the copper find a direct application in a large number of technical domains, such as food processing, the pharmaceutical industry, healthcare, water sports, sport structures, school complexes, construction, public establishments, airports, train stations and the protection of roofs, among others.

However, the copper and/or cupronickel powders used until now have a spherical, disorganized structure, incapable of ensuring a standard and regular thickness and thus making it impossible to provide optimal biocidal protection.

These preferably spherical metal beads present, as indicated above, the risk of confining air bubbles in the thickness of the coating, depicted in FIG. 1. These beads foster the breakdown of the protection necessary between each metal bead and the surface, which must be improved through a relatively abrasive sanding in order to create a smooth surface, but one that is uneven in terms of thickness. Indeed, the surface must be regularly sanded to remove the successive layers of resins over time, so the surface must be re-sanded to create an anti-fouling surface.

There is thus still a need for a biocidal coating composition resolving all of the problems mentioned above.

The technical objective of the present invention is to resolve the technical problems mentioned above by providing a composition containing overlapping copper and/or cupronickel nanoparticles and/or microparticles having a flat lamellar structure, dispersed in a binder comprising notably a thixotropic agent allowing a regular, controlled application with a film of varying thicknesses, thus creating a “placoid scale” coating, and also allowing the antiseptic properties of the copper to be conserved by eradicating molds, bacteria and viruses, all while minimizing manufacturing costs by reducing the amount of epoxy binder used to obtain said composition.

### DESCRIPTION OF THE INVENTION

According to a first aspect, the invention relates to a biocidal coating composition for a surface, comprising overlapping flat lamellar metallic nanoparticles and/or microparticles having a diameter of less than 45 microns, in suspension in a binder comprising:
an epoxy resin;
a thixotropic agent;
a natural diluent selected from among water, preferably demineralized water, and/or ethylene glycol and/or denatured alcohol.

In the sense of the invention, composition is to be understood as a combination of two or more materials of different natures. In the present invention, this is a combination of a binder with metallic nanoparticles and/or microparticles, preferably copper and/or cupronickel and/or metallic. The composition according to the invention makes it possible not to confine air molecules (oxygen) from the protected material(s).

Overlapping flat lamellar particles according to the invention are to be understood as thin plates, each one measuring a few nanometers or a few microns, said plates being thin and flat in shape, juxtaposed and interlocking, forming a smooth mesh with no superficial defects allowing the dispersion of said nanoparticles and/or microparticles into the environment to be avoided while also conserving the antiseptic properties of the copper. These particles have an elongated shape, resembling a flat ovular shape, as schematized in FIG. 3, and shown in a microscopic photograph in FIG. 4, allowing for juxtaposition and interlocking between them.

This resembles the pattern naturally found in the skin of certain reptiles and fishes. For these reasons, the coating is referred to in the text as a “placoid scale” coating. Said “placoid scales” resemble the subcutaneous denticles of cartilaginous fish such as the scales of selachians, namely sharks and rays, forming small, flattened teeth, overlapping in order to play a hydrodynamic role by making the skin of said fishes impermeable. Moreover, said flat lamellar nanoparticles and/or microparticles overlap to allow the coating to which the composition is applied to be made impermeable to external agents such as viruses, bacteria or even the various molds that may form.

The “placoid scale” lamellar nanoparticles ensure homogeneity and guarantee continuity of protection between each nanoparticle and/or microparticle, without any air bubbles being confined.

In the sense of the invention, nanoparticles and/or microparticles are to be understood as small particles, measuring a few nanometers or a few microns, preferably the size of said nanoparticles being between 5 nm and 9 nm and the size of the microparticles being between 1 μm and 20 μm. The diameter of said particles used according to the invention is less than 45 microns.

The present invention allows the powerful naturally biocidal and antibacterial properties of the copper and/or cupronickel in its raw state to be conserved once the material is covered.

In the sense of the present invention, binder is to be understood as a substance that binds the flat lamellar nanoparticles and/or microparticles according to the invention to each other. The binder ensures the cohesion of the nanoparticles and/or microparticles for the formation of a “placoid scale” protection.

The overlapping of said flat lamellar copper and/or cupronickel nanoparticles and/or microparticles allows perfect cohesion of the particles to be guaranteed while minimizing the quantity of binder used.

Epoxy resin is to be understood as thermosetting resins exhibiting good mechanical and chemical properties. These resins comprise a base and a hardening agent. They are manufactured using the polymerization of epoxide monomers with a hardening agent (cross-linking agent), which may have an acid anhydride, phenol or most often amine (polyamine, aminoamide) base: these are tridimensional polymers. As the epoxy resin is a costly element, reducing its use allows the costs accrued and that of the coating composition according to the invention to be reduced. The present invention, by virtue of its overlapping configuration of the particles, makes it possible to use a smaller quantity of epoxy resin, and thus to achieve significant savings on the raw materials of said invention, all while increasing the initial protection of the nanoparticles and/or microparticles used in said composition. Epoxy resin is also to be understood as the polymerization agent thereof. An example of a polymerization agent may be that available on the market under the name RESOLCOAT 1014. This epoxy resin and the polymerization agent can also be those available on the market under the name CLEAR COAT/A and CLEAR COAT/B, respectively, diluted with trichlorethylene ethylene ketone or methyl ethylene ketone.

Preferably, between 1% and 50%, preferably between 5% and 45%, even more preferably between 5% and 35% of the total weight of the composition is made up of said epoxy resin.

Examples of such epoxy resins are available on the market under the name RESOLCOAT 1014, or other brands.

Thixotropic agent is to be understood according to the invention as a dispersion agent, allowing the nanoparticles and/or microparticles used in the formulation of the binder to be held in suspension, and the properties of thixotropy to be added thereto, namely being able to go from a liquid state to a solid state under the effect of a constant constraint. This will allow the composition according to the invention, once placed on the surface to be coated, to employ its biocidal properties. Left untouched for a prolonged period, the thixotropic fluid will restructure itself and allow for transformation into a more or less viscous product, thus allowing the metal particles to be held in suspension. Its viscosity increases and can tend toward infinity, according to the type of mixture desired.

Preferably, between 10% and 45%, preferably between 15% and 45%, even more preferably between 28% and 45% of the weight of said composition is made up of said thixotropic agent.

Preferably, said thixotropic agent is colloidal clay made up of a mixture of sodium, magnesium and lithium silicates.

Even more preferably, said thixotropic agent made up of a mixture of sodium, magnesium and lithium silicates is the product Laponite® RD.

In the sense of the present invention, natural diluent is to be understood as a substance allowing the dilution of different elements making up the coating composition according to the invention.

Said diluent will evaporate entirely after application of the coating composition on the surface to be coated.

Thus, the percentages of composition components addressed here are those before application.

Preferably, said natural diluent is chosen from among water, preferably demineralized water, and/or ethylene glycol and/or denatured alcohol.

Preferably, between 10% and 45%, preferably between 15% and 45%, even more preferably between 28% and 45% of the total weight of the composition is made up of natural diluent.

Preferably, said copper and/or cupronickel nanoparticles have a diameter of between 5 nm and 9 nm.

Preferably, said copper and/or cupronickel microparticles have a diameter of between 1 μm and 20 μm.

According to a preferred embodiment of the invention, between 10% and 95%, preferably between 40% and 95%, even more preferably between 55% and 95% of the total weight of said composition is made up of said nanoparticles and/or microparticles.

In the sense of the invention, biocidal is to be understood as the definition of “biocidal” provided by the European Parliament and Directive 98/8/EC of Feb. 16, 1998, concerning the placing of biocidal products on the market (JO/CE no. L 123 of Apr. 24, 1998), which defines them as “Active substances and preparations containing one or more active substances, put up in the form in which they are supplied to the user, intended to destroy, deter, render harmless, prevent the action of, or otherwise exert a controlling effect on any harmful organism by chemical or biological means.”

Preferably, said metallic nanoparticles and/or microparticles are nanoparticles and/or microparticles made of copper and/or cupronickel.

According to a particular embodiment of the invention, the composition comprises:
between 10% and 95% nanoparticles and/or microparticles;
between 1% and 50% epoxy resin;
between 1% and 30% thixotropic agent, preferably Laponite® RD;
between 10% and 45% diluent, natural, chosen from among water, preferably demineralized water, and/or ethylene glycol and/or denatured alcohol.

According to an alternative embodiment of the invention, the composition comprises:
between 40% and 95% nanoparticles and/or microparticles;
between 5% and 45% epoxy resin;
between 5% and 30% thixotropic agent, preferably Laponite® RD;
between 15% and 45% diluent, natural, chosen from among water, preferably demineralized water, and/or ethylene glycol and/or denatured alcohol.

According to an alternative embodiment of the invention, the composition comprises:
between 55% and 95% nanoparticles and/or microparticles;
between 5% and 35% epoxy resin;
between 5% and 30% thixotropic agent, preferably Laponite® RD;
between 28% and 45% diluent, natural, chosen from among water, preferably demineralized water, and/or ethylene glycol and/or denatured alcohol.

According to an alternative embodiment of the invention, the composition comprises:
between 45% and 99% nanoparticles and/or microparticles;
between 5% and 45% epoxy resin;
between 7% and 45% thixotropic agent, preferably Laponite® RD;
between 28% and 45% diluent, natural, chosen from among water, preferably demineralized water, and/or ethylene glycol and/or denatured alcohol.

The invention provides a composition that can be applied to a surface intended to be submerged or remain in the open air. The application of this composition provides improved efficacy of protection of said surface, submerged or not.

After application to the surface, the composition forms a layer of particles and binder having a thickness approximately five to ten times greater than that of a layer of conventional anti-fouling paint, comparable to a “doubling” of the hull. The very high proportion of overlapping particles allows a fixation of the particles among themselves to be obtained, and thus the dispersion of these particles into the environment to be avoided.

After application to the surface intended to be treated, the coating composition forms a layer of nanoparticles and/or microparticles having a thickness of at least 600 microns, depending on the nature of the material(s) to be coated.

The resistance of the coating according to the invention is increased over time, with no risk of alteration in the air when the treated surface is placed somewhere dry, nor when submerged for several consecutive years. The intrinsic resistance of this layer is also increased, such that it is not damaged by potential maintenance of the surface, for example, the hull of a ship, or another structure comprising the treated surface. The lifetime of such a layer can reasonably be compared with that of a boat itself. In case of accidental degradation, the layer is easy to repair through local reapplication of the product.

This layer can be polished, if needed, by simply rubbing it with a slightly abrasive household sponge, without placing the treated surface somewhere dry, while also respecting the environment.

According to a second embodiment, the invention relates to a surface coating process comprising at least one step of applying to said surface said coating composition according to the invention.

Preferably, said surface coating process furthermore comprises at least one step of drying said coating after said at least one step of application to said surface.

Preferably, said at least one step of application is performed using cold metallization.

The cold metallization technique, by associating metal nanoparticles and/or microparticles with a binder, allows all rigid or semi-rigid materials to be coated, including porous materials. Said invention allows any material to be covered in order to obtain a result that is smooth to the touch while also offering lasting antiseptic protection. The high overlapping flat lamellar copper and/or nickel nanoparticle and/or microparticle content allows for perfect homogeneity among them and forms “placoid” coating protection.

Preferably, said at least one step of application using cold metallization is performed with a spray and/or a paint roller and/or a brush and/or by electrodeposition.

Preferably, said at least one step of application is repeated until a coating with a thickness of at least 600 microns is obtained on the surface to be coated.

According to one embodiment, said process can comprise the application of a specific interface to the surface to be coated before the step of applying the coating composition according to the invention, allowing for longer-lasting maintenance of said composition.

The materials exposed to contact, which cannot be disassembled or are too heavy to transport, will be directly protected where they are with direct protection, with no need to “polish or activate” the process, once they have dried.

The coating made up of lamellar nanoparticles and/or microparticles will, owing to the binder, ensure a “placoid scale” surface preventing any accumulation of viruses or microbes and the confinement of air while also activating the antiseptic properties of the flat lamellar copper and/or nickel and/or metal nanoparticles and/or microparticles.

To treat a surface measuring 10 m², a quantity of 965 grams of product is applied, 96.5 g per m² per layer applied, namely:
270 grams of copper or copper and nickel alloy particles;
600 grams of demineralized water;
90 grams of epoxy resin and this resin's polymerization agent;
0.05 grams of thixotropic agent.

After application, the polymerization of the epoxy resin brings about the evaporation of 15% of this resin, i.e. 5.63 grams, and the demineralized water undergoes 100% evaporation, i.e. 600 grams; the net weight of the applied and polymerized product is thus 116 g per m².

The composition of the dry product per m² is therefore as follows:
90 grams of copper or copper and nickel alloy particles, i.e. 94%;
9 grams of epoxy resin and this resin's polymerization agent, i.e. 6%.

According to a third embodiment, the invention relates to the use of the biocidal surface coating composition according to the invention to coat a surface, porous or nonporous, chosen from among: wood, composite, steel, aluminum, stainless steel, ferrocement, concrete, polyester, epoxide, PCV, rigid or semi-rigid carbon.

According to a fourth embodiment, the invention relates to the use of the biocidal surface coating composition according to the invention to coat the hull of a boat.

### DESCRIPTION OF THE FIGURES

FIG. 1 provides a schematic example of the application of a coating with metal beads, comprising the substrate, copper beads and air bubbles, as can be found in the prior art, for example, in document FR2894974.

FIG. 2 is a microscopic view of spherical copper beads.

FIG. 3 is a schematic example of a lamellar coating according to the invention, the particles of which are flat, ovular and form a “placoid scale” coating.

FIG. 4 is a microscopic view of flat lamellar “placoid scale” nanoparticles, without binder. The flat lamellar “placoid scale” particles are overlapping.

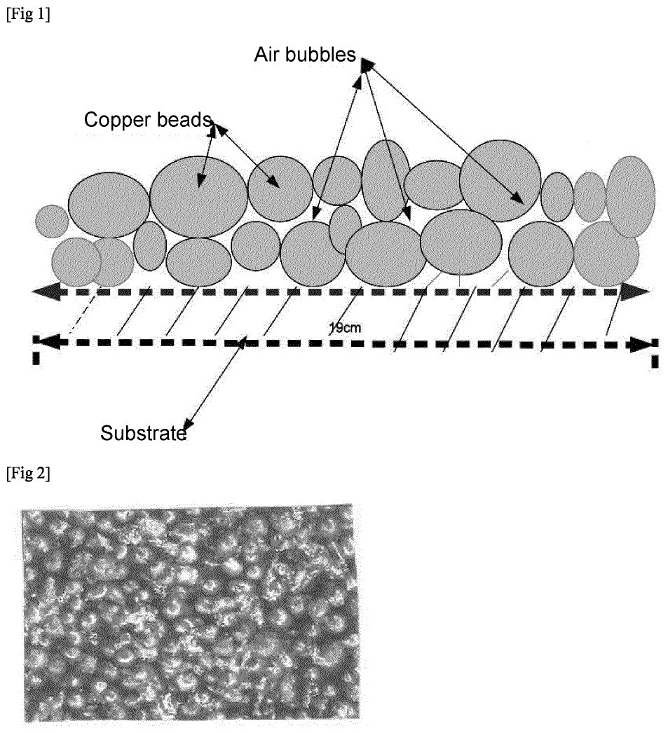

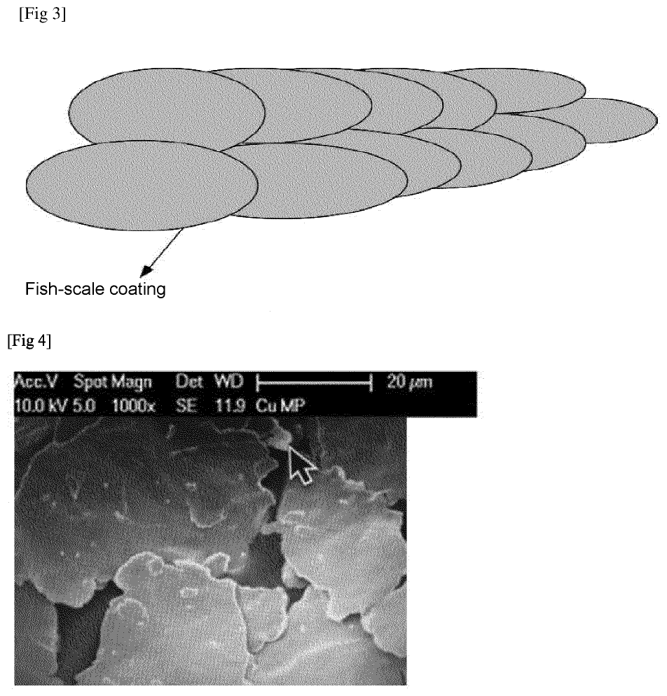

### EXAMPLES

### Example 1

In a test experiment, the coating composition according to the invention is prepared.

This composition according to the invention is then applied using the procedure according to the experiment, comprising a step of cold metallization, to the surface of the hull of a boat.

This boat hull coated with the coating composition according to the invention is then submerged for one month in seawater.

A second boat hull made up of identical material to the coated one is also left for a month in seawater, near the first hull.

At the end of this month, the boat hulls are compared, and it seems that the hull not coated with the composition according to the invention is in a worse state than the one coated with the composition according to the invention. Indeed, marks indicating an attack by living organisms (bacteria, algae, etc.) can be seen on the untreated hull, whereas the boat hull coated with the composition according to the invention is intact.

1. A biocidal coating composition for a surface, comprising overlapping flat lamellar metallic nanoparticles and/or microparticles having a diameter of less than 45 microns, in suspension in a binder comprising:
an epoxy resin;
a thixotropic agent;
a natural diluent selected from among water, preferably demineralized water, and/or ethylene glycol and/or denatured alcohol.

2. A biocidal coating composition for a surface according to claim 1, wherein said metallic nanoparticles and/or microparticles are copper and/or cupronickel nanoparticles and/or microparticles.

3. A biocidal coating composition for a surface according to claim 1, wherein between 10% and 95%, preferably between 40% and 95%, more preferably between 55% and 95% of the total weight of the composition is made up of said nanoparticles and/or microparticles.

4. A biocidal coating composition for a surface according to claim 1, wherein between 1% and 50%, preferably between 5% and 45%, more preferably between 5% and 35% of the total weight of the composition is made up of said epoxy resin.

5. A biocidal coating composition for a surface according to claim 1, wherein between 10% and 45%, preferably between 15% and 45%, more preferably between 28% and 45% of the total weight of the composition is made up of said thixotropic agent.

6. A biocidal coating composition for a surface according to claim 1, wherein said thixotropic agent is colloidal clay made up of a mixture of sodium, magnesium and lithium silicates.

7. A surface coating process comprising at least one step of applying to said surface said coating composition according to claim 1.

8. A surface coating process according to claim 7, wherein it furthermore comprises at least one step of said coating drying after said at least one step of application to said surface.

9. A surface coating process according to claim 7, wherein said at least one step of application is performed using cold metallization.

10. A surface coating process according to claim 9, wherein said at least one step of application using cold metallization is performed with a spray and/or a paint roller and/or a brush and/or by electrodeposition.

11. A surface coating process according to claim 7, wherein said at least one step of application is repeated until a coating having a thickness of at least 600 microns is obtained.

12. Use of the biocidal coating composition for a surface according to claim 1 to coat a surface, porous or nonporous, chosen from among: wood, composite, steel, aluminum, stainless steel, ferrocement, concrete, polyester, epoxide, PCV, rigid or semi-rigid carbon.

13. Use of the biocidal coating composition for a surface according to claim 1 to coat the hull of a boat.
